(19) United States
(12) Patent Application Publication
(10) Pub. No.: US 2026/0195084 A1
(43) Pub. Date: Jul. 9, 2026

(54) CODE-BASED GUEST PRINTING FOR CLOUD-BASED PRINTING SOFTWARE SOLUTIONS

(71) Applicant: Toshiba Tec Kabushiki Kaisha, Tokyo (JP)

(72) Inventors: Matthew CHAN, Lake Forest, CA (US); Christopher NGUYEN, Irvine, CA (US); Silvy WILSON, Rancho Santa Margarita, CA (US)

(21) Appl. No.: 19/242,211

(22) Filed: Jun. 18, 2025

Related U.S. Application Data
(60) Provisional application No. 63/741,788, filed on Jan. 3, 2025.

(51) Int. Cl. G06F 3/12

(52) U.S. Cl. CPC G06F 3/1238; G06F 3/1222; G06F 3/1287

(57) ABSTRACT

A cloud printing service computer is configured to manage print jobs of a printer, by performing the steps of: designating a guest printing authorization uniform resource locator (URL); in response to an authorization request received at a network address corresponding to the guest printing authorization URL from a computer of a guest user, transmitting a first print authorization code to the computer of the guest user; in response to a verification request received from the printer that includes a second print authorization code, verifying the second print authorization code by at least comparing the first and second print authorization codes to determine that the first and second print authorization codes match; and in response to verifying the second print authorization code, transmitting a message to the printer indicating that the second print authorization code has been successfully validated for executing a print job of the guest user.

### CROSS-REFERENCE TO RELATED APPLICATION

This application is based upon and claims the benefit of priority from U.S. Provisional Ser. No. 63/741,788 , filed Jan. 3, 2025, the entire contents of which are incorporated herein by reference.

### FIELD

Embodiments to be described herein generally relate to a cloud printing service computer that manages print jobs of a printer.

### BACKGROUND

Cloud-based printing software solutions allow users to print files using the Internet without needing to directly connect to a printer. For example, the printer may be a multi-function printer (MFP), which is a computer peripheral that is capable of performing several functions such as printing, scanning, copying, and faxing. Using cloud-based printing, the users may upload print jobs to a cloud server, which the printer then downloads for executing. As used herein, a print job is a task for a printer to print a file, and a print job includes the file and settings such as whether to print the file in color or in black and white.

In some situations, there is a need for a guest user (e.g., of a company) to print using one of the company's printers. A guest user is an individual who is not a regular user, employee or member of an organization that owns or operates a cloud-based printing solution, but who may be temporarily granted access to printing functionality. Typically, cloud-based printing software solutions require a lengthy registration process before such a guest user is able to execute a print job. For example, to register with the company, the guest user may first need to access a web-based portal of the company. In the portal, the guest user may enter various information such as their email address, a username, a password, and a personal identification number (PIN) to create an account. A PIN is a numerical code, including, e.g., 6-8 digits.

Once the guest user creates a registered account, the guest user may upload a print job to a cloud server. The printer may then download the print job from the cloud server and execute the print job. Unfortunately, the registration process may be excessively time consuming, especially for a guest user who may only need to print at the company a small number of times, perhaps only on one occasion. A more efficient process is desired for executing print jobs for a guest user.

### BRIEF DESCRIPTION OF THE DRAWINGS

FIG. 1 is a block diagram of a computer system in which embodiments may be implemented.

FIG. 2 is a flow diagram of a method that may be performed by computers of the computer system to upload a print job, according to some embodiments.

FIG. 3 is a flow diagram of a method that may be performed by a printer and a computer of the computer system to execute the print job, according to some embodiments.

### DETAILED DESCRIPTION

One or more embodiments provide a cloud printing service computer including a processor and memory, wherein the processor executes instructions stored in the memory to manage print jobs of a printer. The cloud printing service computer performs the steps of: designating a guest printing authorization uniform resource locator (URL); in response to an authorization request received at a network address corresponding to the guest printing authorization URL from a computer of a guest user, transmitting a first print authorization code to the computer of the guest user; in response to a verification request received from the printer that includes a second print authorization code, verifying the second print authorization code by at least comparing the first and second print authorization codes to determine that the first and second print authorization codes match; and in response to verifying the second print authorization code, transmitting a message to the printer indicating that the second print authorization code has been successfully validated for executing a print job of the guest user. Further embodiments include a method comprising the above steps and a non-transitory computer-readable storage medium comprising instructions that cause a cloud printing service computer to carry out the above steps.

The embodiments provide for a more efficient process for a guest user (referred to herein simply as a “guest”) to execute print jobs. The embodiments do not require the guest to first register before being able to print. Instead, the guest is provided with a code-based guest printing solution. As used herein, “guest printing” refers to a printing option for a guest such as a visitor of a company, to print without registering, e.g., to print without creating a registered account with the company.

According to embodiments, a print authorization code such as a PIN is provided to the guest, which the guest may enter at a printer to execute a print job. Acquiring the PIN does not require a lengthy registration process, thus enabling a computer system to more quickly execute the print job for the guest. Furthermore, the computer system still authenticates the guest based on the PIN, to avoid providing guest printing services to unintended people. Hereinafter, embodiments will be described with reference to the drawings. In the drawings, the same reference symbols denote the same or similar portions.

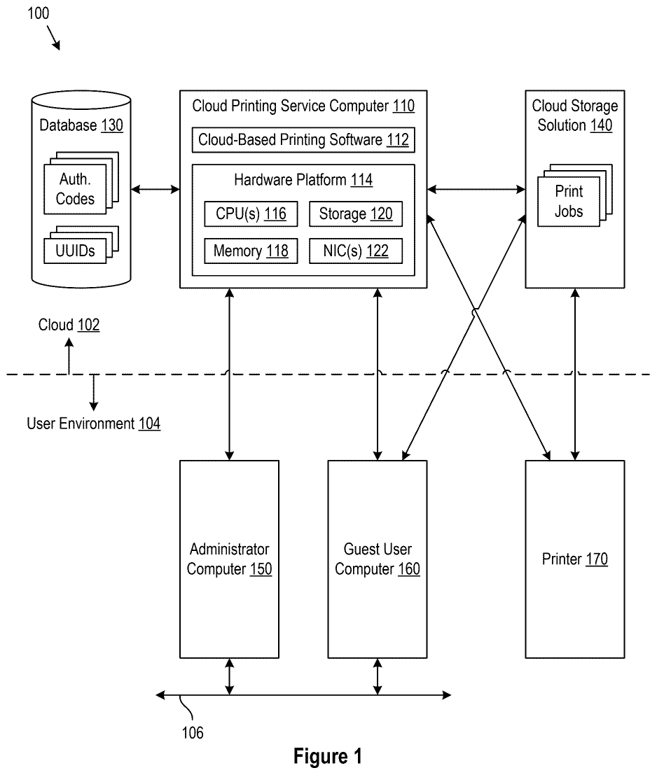

FIG. 1 is a block diagram of a computer system 100 in which embodiments may be implemented. In the example of FIG. 1, computer system 100 includes a cloud 102 and a user environment 104. User environment 104 is a computing environment in which a guest may execute print jobs on a printer 170 that supports cloud-based printing. For example, user environment 104 may be an on-premises computing environment of a company, and the guest may be a visitor who is not an employee of the company. Cloud 102 may include, e.g., one or more public and/or private cloud datacenters. In the example of FIG. 1, cloud 102 includes a cloud printing service computer 110, a database 130, and a cloud storage solution 140.

Cloud printing service computer 110 is a computer such as a server computer that performs functionalities for supporting cloud-based printing for employees and guests. Cloud printing service computer 110 is constructed on a hardware platform 114 such as an x86 architecture platform. Hardware platform 114 includes components of a computer, such as one or more central processing units (CPUs) 116, memory 118 such as random-access memory (RAM), local storage 120 such as one or more magnetic drives or solid-state drives (SSDs), and one or more network interface controllers (NICs) 122. CPU(s) 116 are configured to execute instructions such as executable instructions that perform one or more operations described herein, which may be stored in memory 118. NIC(s) 122 enable cloud printing service computer 110 to communicate with other devices over a network such as the Internet.

Hardware platform 114 supports cloud-based printing software 112 for managing cloud-based printing for employees and guests, e.g., for the company of user environment 104. One example of cloud-based printing software 112 is Elevate Sky,® available from Toshiba Tec Corporation. Database 130 is a structured collection of data that is used by cloud printing service computer 110 to manage the cloud-based printing. As illustrated in FIG. 1, database 130 may be external from cloud printing service computer 110, including, e.g., one or more magnetic drives or SSDs. Alternatively, for example, database 130 may be stored locally in storage 120 of cloud printing service computer 110.

Database 130 stores information for managing cloud-based printing for guests such as print authorization codes and universally unique identifiers (UUIDs). The print authorization codes may be, e.g., 6-8-digit PINs, and the UUIDs may be, e.g., strings of numbers and letters. The print authorization codes and UUIDs may be generated by cloud printing service computer 110 and stored in database 130 thereby. The print authorization codes and UUIDs are discussed further below.

Cloud storage solution 140 is a service that allows individuals or organizations such as the company of user environment 104, to store data remotely. For example, cloud storage solution 140 may be Amazon Simple Storage Service (S3™), available from Amazon Web Services (AWS). Cloud storage solution 140 may include one or more server computers (not shown) configured to communicate over the Internet and configured to manage the data. The data may be stored, e.g., in magnetic drives or SSDs (not shown) accessible to the server computer(s). According to embodiments, the data stored by cloud storage solution 140 includes print jobs uploaded, e.g., from user environment 104 by employees and guests.

In the example of FIG. 1, user environment 104 includes an administrator computer 150, a guest user computer 160, and a printer 170. Administrator computer 150 is a computer such as a desktop computer or laptop computer of an administrator. For example, the administrator may be an employee of the company of user environment 104. Guest user computer 160 is a computer such as a laptop computer or smartphone of a guest that has one or more print jobs to execute. For example, the guest may be someone who is not an employee of the company of user environment 104 and who thus is not registered for the company's cloud-based printing.

Administrator computer 150 and guest user computer 160 are each constructed on hardware platforms (not shown) similar to hardware platform 114 of cloud printing service computer 110. For example, administrator computer 150 and guest user computer 160 each include one or more CPUs and memory such as RAM. The CPUs are configured to execute instructions such as executable instructions that perform one or more operations described herein, which may be stored in the memory of the respective computers. Administrator computer 150 and guest user computer 160 may also each include one or more NICs for communicating with other devices over networks, including the Internet and a network 106 such as a local area network (LAN) of the company.

Printer 170 is a device that is configured to support cloud-based printing, e.g., for the company of user environment 104. For example, printer 170 may be an MFP that also provides other functions in addition to printing such as scanning, copying, and faxing. Printer 170 may be configured to communicate with cloud printing service computer 110 and cloud storage solution 140 over the Internet.

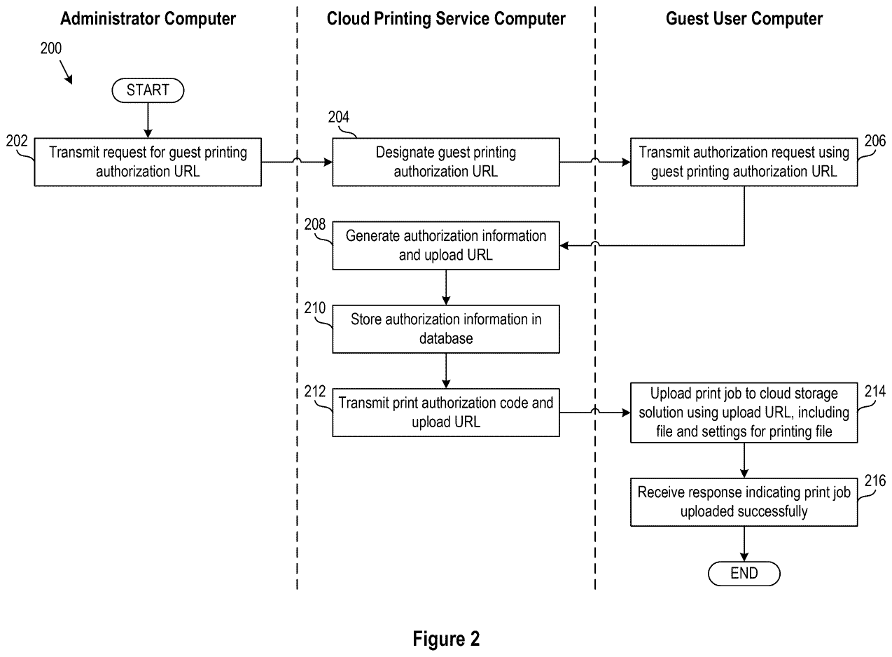

FIG. 2 is a flow diagram of a method 200 that may be performed by administrator computer 150, cloud printing service computer 110, and guest user computer 160 to upload a print job, according to some embodiments. At step 202, administrator computer 150 transmits a request to cloud printing service computer 110 for a guest printing authorization URL. The guest printing authorization URL is a URL associated with cloud printing service computer 110, and may be used by a guest to gain authorization to perform guest printing. For example, cloud printing service computer 110 may store the guest printing authorization URL in a quick response (QR) code, which is a two-dimensional barcode.

At step 204, cloud printing service computer 110 designates the guest printing authorization URL for requesting guest printing authorization. For example, cloud printing service computer 110 may transmit the guest printing authorization URL to administrator computer 150. The administrator may then provide the guest printing authorization URL to the guest. For example, administrator computer 150 may transmit an email to guest user computer 160 that includes the guest printing authorization URL. As another example, if cloud printing service computer 110 stores the guest printing authorization URL in a QR code and then transmits the QR code to administrator computer 150, the administrator may print an image of the QR code and place the printed image near printer 170.

At step 206, guest user computer 160 transmits an authorization request to cloud printing service computer 110 using the guest printing authorization URL, i.e., transmits the authorization request to a network address corresponding to the guest printing authorization URL. For example, if guest user computer 160 received the guest printing authorization URL in an email, the guest may open the email on guest user computer 160 and select the guest printing authorization URL. As another example, if the administrator placed an image of a QR code near printer 170, the guest may scan the QR code using guest user computer 160. Guest user computer 160 may transmit the authorization request to cloud printing service computer 110 in response to the guest selecting the guest printing authorization URL or scanning the QR code.

At step 208, cloud printing service computer 110 generates authorization information for the guest and an upload URL. The authorization information may include, e.g., a print authorization code for the guest and a corresponding UUID for the guest. The upload URL is a URL that designates a location of cloud storage solution 140 at which the guest may upload a print job to be executed. For example, the upload URL may include the UUID, thus associating the upload URL to the guest.

At step 210, cloud printing service computer 110 stores the authorization information in database 130. For example, cloud printing service computer 110 may store the print authorization code and the UUID in association with each other. Cloud printing service computer 110 may further store other information such as a creation time of the print authorization code and a time-to-live (TTL) thereof, which indicates how long the print authorization code is valid, e.g. for one hour. At step 212, cloud printing service computer 110 transmits the print authorization code and the upload URL to guest user computer 160. It should be noted that although illustrated as a single step, cloud printing service computer 110 may transmit the print authorization code and upload URL separately. For example, cloud printing service computer 110 may first transmit the upload URL to guest user computer 160. Then, upon receiving an indication from cloud storage solution 140 that the guest has successfully uploaded a print job thereto, cloud printing service computer 110 may transmit the print authorization code to guest user computer 160.

At step 214, guest user computer 160 uploads a print job to cloud storage solution 140 using the upload URL, i.e., transmits the print job to a network address corresponding to the upload URL. The print job includes a file to print along with settings for printing the file such as whether to print the file in color or in black and white and a number of copies of the file to print. For example, the file may be a word-processing document or an image. Upon receiving the print job, cloud storage solution 140 stores the print job. For example, if the upload URL includes the UUID, cloud storage solution 140 may store the print job in a folder named based on the UUID. At step 216, guest user computer 160 receives a response from cloud storage solution 140 indicating that the print job has been uploaded successfully. After step 216, method 200 ends.

It should be noted that a guest may have more than one print job to execute, each including a file to print and settings for printing the file. Accordingly, cloud printing service computer 110 may, in response to one or more authorization requests from guest user computer 160, generate multiple upload URLs, one for each print job, and transmit each upload URL to guest user computer 160. Each of such upload URLs may include the same UUID but still be associated by cloud storage solution 140 with a different print job. Guest user computer 160 may then upload each print job to cloud storage solution 140 using respective upload URLs, and cloud storage solution 140 may store the print jobs, e.g., together in a single folder named based on the UUID.

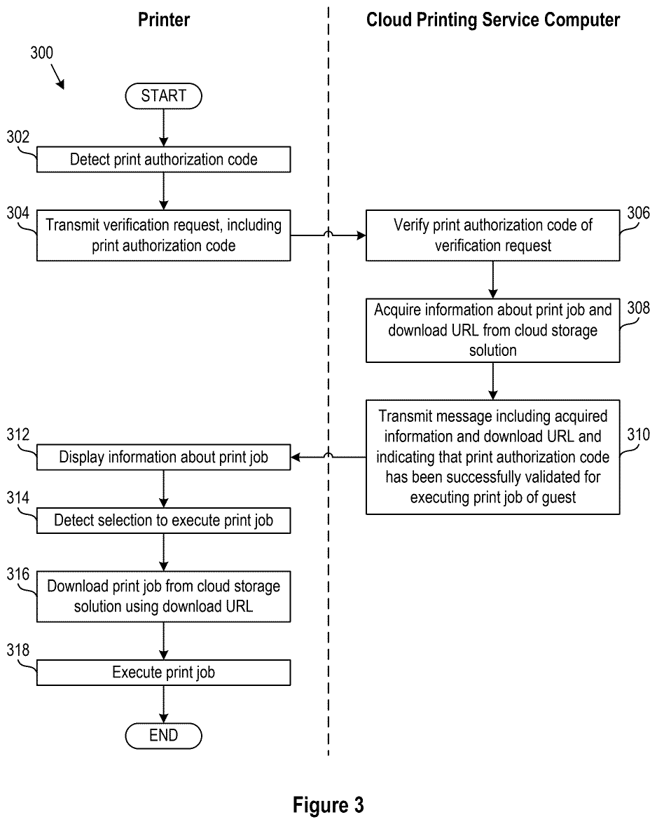

FIG. 3 is a flow diagram of a method 300 that may be performed by printer 170 and cloud printing service computer 110 to execute a print job, according to some embodiments. At step 302, printer 170 detects a print authorization code. For example, a guest may enter the print authorization code on a display panel of printer 170 after guest user computer 160 receives the print authorization code from cloud printing service computer 110. At step 304, printer 170 transmits a verification request to cloud printing service computer 110. The verification request includes the detected print authorization code.

At step 306, cloud printing service computer 110 verifies the print authorization code of the verification request. For example, as part of the verification, cloud printing service computer 110 may compare the print authorization code of the verification request to print authorization codes stored in database 130 to determine that the print authorization code of the verification request matches one of the stored print authorization codes. Additionally, for example, as part of the verification, cloud printing service computer 110 may compare a creation time and TTL of the matching print authorization code from database 130, to determine that the print authorization code has not expired.

At step 308, cloud printing service computer 110 acquires information from cloud storage solution 140 about a print job of the guest and acquires a download URL from cloud storage solution 140. For example, cloud printing service computer 110 may transmit a request to cloud storage solution 140, the request including the UUID of the guest, which cloud printing service computer 110 retrieves from database 130. Cloud storage solution 140 may then locate a folder named based on the UUID and transmit information about the print job to cloud printing service computer 110 along with the download URL. The information includes, e.g., a name of a file of the print job, the number of pages of the file, and settings for the print job. The download URL is a URL that designates a location of cloud storage solution 140 for downloading the print job. Similar to the upload URL, the download URL may include the UUID of the guest. However, whereas the upload URL may be optimized by cloud storage solution 140 for making data uploads faster, the download URL may be optimized by cloud storage solution 140 for reducing the latency and increasing the throughput of data downloads.

At step 310, cloud printing service computer 110 transmits a message to printer 170, including the acquired information about the print job and the download URL. Transmitting such message indicates to printer 170 that the print authorization code from the verification request has been successfully validated for executing the print job. At step 312, printer 170 displays the information about the print job, e.g., on a display panel thereof. At step 314, printer 170 detects a selection to execute the print job. For example, the guest may make such selection by pressing the display panel of printer 170.

At step 316, printer 170 downloads the print job from cloud storage solution 140 using the download URL, i.e., downloads the print job from a network address corresponding to the download URL. At step 318, printer 170 executes the print job by printing the file according to the settings of the print job. For example, printer 170 may print one or more copies of the file according to the settings. As another example, printer 170 may either print the file in color or in black and white according to the settings. After step 318, method 300 ends.

It should be noted that a guest may have more than one print job to execute, each including a file to print and settings for printing the file. Accordingly, cloud storage solution 140 may provide cloud printing service computer 110 with multiple download URLs, one for each print job. Each of such download URLs may include the same UUID but still be associated by cloud storage solution 140 with a different print job. Cloud printing service computer 110 may then transmit each download URL to printer 170 in response to one or more verification requests from printer 170. Printer 170 may then download each print job from cloud storage solution 140 using respective download URLs, and printer 170 may then print each of the files according to the settings of the print jobs.

Additionally, while method 300 only illustrates a single step for printer 170 to transmit the verification request, embodiments are not limited as such. For example, printer 170 may transmit the detected print authorization code to cloud printing service computer 110, which transmits a session token back to printer 170 in response. Printer 170 may then transmit the session token to cloud printing service computer 110, which transmits the acquired information and download URL to printer 170 in response. The session token may be a unique identifier generated by cloud printing service computer 110 with a TTL, e.g., for an hour.

While certain embodiments have been described, these embodiments have been presented by way of example only, and are not intended to limit the scope of the invention. Indeed, the novel embodiments described herein may be embodied in a variety of other forms. Furthermore, various omissions, substitutions, and changes in the form of the embodiments described herein may be made without departing from the spirit of the invention. The accompanying claims and their equivalents are intended to cover such forms or modifications as would fall within the scope and spirit of the invention.

What is claimed is:

1. A cloud printing service computer including a processor and memory, wherein the processor executes instructions stored in the memory to manage print jobs of a printer by performing the following steps:
designating a guest printing authorization uniform resource locator (URL);
in response to an authorization request received at a network address corresponding to the guest printing authorization URL, from a computer of a guest user, transmitting a first print authorization code to the computer of the guest user;
in response to a verification request received from the printer that includes a second print authorization code, verifying the second print authorization code by at least comparing the first and second print authorization codes to determine that the first and second print authorization codes match; and
in response to verifying the second print authorization code, transmitting a message to the printer indicating that the second print authorization code has been successfully validated for executing a print job of the guest user.

2. The cloud printing service computer of claim 1, wherein the steps further include:
transmitting the guest printing authorization URL to a computer of an administrator that is separate from the computer of the guest user.

3. The cloud printing service computer of claim 2, wherein the steps further include:
storing the guest printing authorization URL in a quick response (QR) code and transmitting the QR code to the computer of the administrator, the authorization request being received from the computer of the guest user in response to the QR code being scanned by the computer of the guest user.

4. The cloud printing service computer of claim 1, wherein the steps further include:
in response to the authorization request received from the computer of the guest user, transmitting an upload URL to the computer of the guest user, the upload URL designating a location of a cloud storage solution to upload the print job to.

5. The cloud printing service computer of claim 4, wherein the steps further include:
in response to the authorization request received from the computer of the guest user, storing the first print authorization code in a database in association with a universally unique identifier (UUID), the upload URL including the UUID.

6. The cloud printing service computer of claim 1, wherein the steps further include:
in response to the verification request received from the printer, verifying the second print authorization code by at least checking a creation time and time to live (TTL) of the first print authorization code to determine that the first print authorization code has not expired.

7. The cloud printing service computer of claim 1, wherein the steps further include:
in response to verifying the second print authorization code, transmitting a download URL to the printer, the download URL designating a location of a cloud storage solution to download the print job from.

8. A method of managing print jobs of a printer, the method comprising:
designating a guest printing authorization uniform resource locator (URL);
in response to an authorization request received at a network address corresponding to the guest printing authorization URL, from a computer of a guest user, transmitting a first print authorization code to the computer of the guest user;
in response to a verification request received from the printer that includes a second print authorization code, verifying the second print authorization code by at least comparing the first and second print authorization codes to determine that the first and second print authorization codes match; and
in response to verifying the second print authorization code, transmitting a message to the printer indicating that the second print authorization code has been successfully validated for executing a print job of the guest user.

9. The method of claim 8, further comprising:
transmitting the guest printing authorization URL to a computer of an administrator that is separate from the computer of the guest user.

10. The method of claim 9, further comprising:
storing the guest printing authorization URL in a quick response (QR) code and transmitting the QR code to the computer of the administrator, wherein the authorization request is received from the computer of the guest user in response to the QR code being scanned by the computer of the guest user.

11. The method of claim 8, further comprising:
in response to the authorization request received from the computer of the guest user, transmitting an upload URL to the computer of the guest user, wherein the upload URL designates a location of a cloud storage solution to upload the print job to.

12. The method of claim 11, further comprising:
in response to the authorization request received from the computer of the guest user, storing the first print authorization code in a database in association with a universally unique identifier (UUID), wherein the upload URL includes the UUID.

13. The method of claim 8, further comprising:
in response to the verification request received from the printer, verifying the second print authorization code by at least checking a creation time and time to live (TTL) of the first print authorization code to determine that the first print authorization code has not expired.

14. The method of claim 8, further comprising:
in response to verifying the second print authorization code, transmitting a download URL to the printer, wherein the download URL designates a location of a cloud storage solution to download the print job from.

15. A non-transitory, computer-readable medium comprising instructions that are executable in a cloud printing service computer, wherein the instructions when executed cause the cloud printing service computer to carry out a method of managing print jobs of a printer, and wherein the method comprises:
designating a guest printing authorization uniform resource locator (URL);
in response to an authorization request received at a network address corresponding to the guest printing authorization URL, from a computer of a guest user, transmitting a first print authorization code to the computer of the guest user;
in response to a verification request received from the printer that includes a second print authorization code, verifying the second print authorization code by at least comparing the first and second print authorization codes to determine that the first and second print authorization codes match; and
in response to verifying the second print authorization code, transmitting a message to the printer indicating that the second print authorization code has been successfully validated for executing a print job of the guest user.

16. The non-transitory, computer-readable medium of claim 15, wherein the method further comprises:
transmitting the guest printing authorization URL to a computer of an administrator that is separate from the computer of the guest user.

17. The non-transitory, computer-readable medium of claim 16, wherein the method further comprises:
storing the guest printing authorization URL in a quick response (QR) code and transmitting the QR code to the computer of the administrator, the authorization request being received from the computer of the guest user in response to the QR code being scanned by the computer of the guest user.

18. The non-transitory, computer-readable medium of claim 15, wherein the method further comprises:
in response to the authorization request received from the computer of the guest user, transmitting an upload URL to the computer of the guest user, the upload URL designating a location of a cloud storage solution to upload the print job to.

19. The non-transitory, computer-readable medium of claim 18, wherein the method further comprises:
in response to the authorization request received from the computer of the guest user, storing the first print authorization code in a database in association with a universally unique identifier (UUID), the upload URL including the UUID.

20. The non-transitory, computer-readable medium of claim 15, wherein the method further comprises:
in response to the verification request received from the printer, verifying the second print authorization code by at least checking a creation time and time to live (TTL) of the first print authorization code to determine that the first print authorization code has not expired.
